(19) United States
(12) Patent Application Publication
(10) Pub. No.: US 2002/0038433 A1
(43) Pub. Date: Mar. 28, 2002

(54) System and method for utilizing programmed multi-speed operation with a microprocessor to reduce power consumption

(75) Inventors: Monte J. Dalrymple, Livermore, CA (US); Norman L. Rogers, Davis, CA (US)

Correspondence Address: John P. O'Banion, O'BANION & RITCHEY LLP, Suite 1550, 400 Capitol Mall, Sacramento, CA, 95814, US

(73) Assignee: Z-WORLD, INC., DAVIS, CA

(21) Appl. No.: 09/894,909

(22) Filed: Jun. 27, 2001

Related U.S. Application Data
(60) Provisional application No. 60/214,709, filed on Jun. 28, 2000.

(51) Int. Cl. G06F 1/26; G06F 1/28; G06F 1/30

(52) U.S. Cl. 713/322

(57) ABSTRACT

A system and method is described for modulating the operating speed of a microprocessor, or other processing element, and the duration of chip select signals in response to the selected microprocessor operating speed. The microprocessor clock is modulated by division, multiplication, or alternative clock selection, as directed by instructions executing on the microprocessor. Power consumption by the microprocessor may be thereby reduced under program control in accord with the required level of processor activity. As the power consumed by typical peripheral devices is largely proportional to the activity of the chip select input at a given operating voltage, the present invention further describes circuits and methods of modulating the duration of the chip select outputs from a microprocessor responsive to the operating speed of the microprocessor to lower power dissipation levels within the associated peripheral devices.

### CROSS-REFERENCE TO RELATED APPLICATIONS

This application claims priority from U.S. provisional application Serial No. 60/214,709 filed on Jun. 28, 2000.

### STATEMENT REGARDING FEDERALLY SPONSORED RESEARCH

### OR DEVELOPMENT

Not Applicable

### REFERENCE TO A MICROFICHE APPENDIX

Not Applicable

### NOTICE OF MATERIAL SUBJECT TO COPYRIGHT PROTECTION

A portion of the material in this patent document is subject to copyright protection under the copyright laws of the United States and of other countries. A portion of the material in this patent document is also subject to protection under the maskwork registration laws of the United States and of other countries. The owner of the copyright and maskwork rights has no objection to the facsimile reproduction by anyone of the patent document or the patent disclosure, as it appears in the United States Patent and Trademark Office file or records, but otherwise reserves all copyright and maskwork rights whatsoever. The copyright and maskwork owner does not hereby waive any of its rights to have this patent document maintained in secrecy, including without limitation its rights pursuant to 37 C.F.R. § 1.14.

### BACKGROUND OF THE INVENTION

1. Field of the Invention

The invention pertains generally to reduced power operating modes within microprocessor circuits and more particularly to circuits and methods of providing programmed multi-speed microprocessor operation to reduce power consumption.

2. Description of the Background Art

Microprocessors, and processing elements in general, operate in conjunction with an oscillator whose frequency, or clock speed, determines the number of instructions which may be executed per a given unit of time. Typically, the period of oscillation is divided into a series of cycles, such as from two to eight, that are utilized within the processing element to control the timing of operations, such as instruction fetch, data in, instruction decode, data out, and memory write, which must be performed during the execution of a given instruction. Oscillators for driving processor clocks are typically implemented with at least an oscillator crystal being connected external to the processor, yet the entire oscillator may alternatively be incorporated within the processor device itself such as in the case of low-cost microcontrollers.

Processing elements are designed for operation within a clock frequency range that is typically subject to a specified maximum clock speed. In embedded processor applications, the processors are often configured for operation at the minimum clock rate that will supply the execution rate necessary to meet worst case peak event conditions. Attempting to minimize clock rate is especially important in portable systems because processor power consumption is substantially proportional to the clock speed of the processor. Power is also consumed by peripheral circuits that interface with the processor, such as memory devices and port devices. The power dissipation within these peripheral circuits is often largely determined by the percentage of time the device is maintained in an active state. It will be appreciated, however, that the amount of processing that must be performed to meet peak event conditions within an application may exceed average processing requirements by orders of magnitude. When not subject to peak event conditions, the processor may spend the vast majority of execution cycles within waiting loops and polling loops as it awaits the detection of events. It should be appreciated, however, that the processor consumes substantially the same power whether it is executing instructions within a waiting loop or instructions that perform useful operations at peak event conditions.

Therefore, in order to reduce processor power consumption a number of processors have been configured with low power modes in which the processor “sleeps” during periods of relative inactivity to be “awakened” upon the arrival of an event or the expiration of a timer. A number of drawbacks, however, exist with the use of sleep modes within processor based circuits. The processor has a limited response to external stimuli while in sleep mode causing events to be missed. Periodically, while in sleep mode, the processor must awaken for short intervals to determine the state of the system and check for events, during which time the processor executes instructions at the peak clock speed with a commensurate high level of power dissipation. In addition, devices such as memories and ports may need to be configured with their own low power sleep mode which must be synchronized with the processor sleep mode so that peripheral power dissipation is reduced. It will be appreciated that sleep modes are best suited to systems whose event conditions may be characterized as either active or non-active. In contrast, the majority of real time microprocessor applications require the handling of a range of event activity levels while operating at reduced power levels.

Therefore, a need exists for a circuit and method of providing a lower power operating mode for a processor and its associated memory and other peripheral circuitry that is not subject to the drawbacks inherent with sleep mode circuits. The present invention satisfies those needs, as well as others, and overcomes the deficiencies of previously developed power-saving circuits and methods.

### BRIEF SUMMARY OF THE INVENTION

A processing element according to the present invention is configured to conserve power under program control by selective reduction in processor clock frequency which is preferably accompanied by a selective reduction in the duration of chip select outputs to peripheral circuits. The selective reduction in processor clock speed may be referred to as programmed multi-speed operation, wherein the program executing on the processor is capable of controlling the execution speed of the processor. The present invention is applicable to any form of electronic processing element, circuit, or device, such as microprocessor, microcontroller, digital-signal processor, central processor unit (CPU), and so forth, which are subject to reduced activity requirements and capable of executing programmed instructions. For the sake of simplicity, the term microprocessor will be used herein to refer to any form of processing element whose rate of instruction execution and power dissipation is dependent on the frequency of the oscillator utilized. Multiple modes of oscillator frequency reduction are exemplified within the present invention. In one mode, referred to as “divider mode”, a high frequency clock is divided by a programmable divider, such as a binary division value, between the clock input or oscillator and the microprocessor which allows the microprocessor clock speed to be modulated. Oscillator speed division values which exceed unity result in reduced processor operating speed, while division values less than unit result in multiplying the oscillator speed in a “multiplier mode” to increase processor speed during high activity periods. An alternate clock mode is also supported in the described embodiments, wherein a second oscillator is selected for driving processor oscillation. Although the second oscillator may be selected for any allowable oscillation frequency, it is preferably configured as a very low frequency oscillator, such as that which is utilized for driving the real-time clock (RTC) circuitry.

A microprocessor operating within a circuit is typically configured with chip select outputs which provide for activation of peripheral devices, such as memory and input/output devices. In addition, write strobes and output enable strobe outputs are utilized for timing writes and reads of data from the peripheral devices. It should be appreciated that typical industry standard static memory devices exhibit substantially increased levels of power dissipation while the chip select line is held active. In view of the fact that peripheral devices are chosen for compatibility with processor peak oscillation rate for the given application, it should be appreciated that reducing the oscillator frequency of the processor will result in maintaining a chip enabled condition within the device, such as a memory device, for a period of time which exceeds the time required by the device to assure access. The access time being determined by the peripheral device itself in relation to a received write, read, or enable strobe, as subject to address time setup requirements.

The circuits and methods taught within the present invention provide for reducing, or minimizing, the period of time during which peripheral devices are selected and thereby reducing peripheral circuit power consumption when subject to a reduced frequency of oscillation. One aspect of the present invention provides the capability to modulate the duration of chip select signals to the peripherals in response to changes in processor clock speed. Chip select modulation may be implemented within a chip select timing circuit that utilizes processor timing or control signals, and may additionally include separate timing circuits, which are logically combined for the generation of a chip select timing signal that is responsive to processor clock speed. The chip select timing signal is then applied to alter the duration of the chip select signals being output, such as by being gated with conventional chip select outputs. By way of example, the modulation of chip select duration may be utilized to interface with a memory device. It will be appreciated that when a microprocessor clock has been slowed down it is not necessary to activate the memory device chip select for the entire cycle because the memory access time is typically far less than the duration over which a conventional processor operating at a reduced frequency will retain the chip select in an active mode. The present invention is directed to a number of objects for reducing power consumption within processors and related circuitry.

An object of the invention is to provide a circuit and method of reducing power consumption within a processor element subject to reduced activity requirements.

Another object of the invention is to provide a circuit and method for reducing the time over which peripheral devices are unnecessarily selected during access cycles.

Another object of the invention is to provide a method of configuring microprocessors with a low power mode that may be easily implemented.

Another object of the invention is to provide a circuit and method of configuring a microprocessor with flexible instruction execution speed selection features.

Another object of the invention is to provide a microprocessor with chip select circuitry that is capable of reducing the percentage of cycle time which is accorded to chip select outputs in response to reduced processor clock speed.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a block diagram of a processing element (CPU) according to an embodiment of the present invention, shown selectably modulating the clock frequency and modifying the duration of peripheral chip selects.

FIG. 2 is a block diagram of a processor circuit configured for multiple speed oscillator modes according to an aspect of the present invention, which is shown controlling the relative duration of a set of chip select outputs.

FIG. 3 is a schematic of a circuit for modulating chip select duration according to an aspect of the present invention, showing chip select duration modification.

FIG. 4 is a timing diagram for the circuit shown in FIG. 3 subject to a cycle limitation.

FIG. 5 is a timing diagram for the circuit shown in FIG. 3 subject to a output enable time duration limitation.

### DETAILED DESCRIPTION OF THE INVENTION

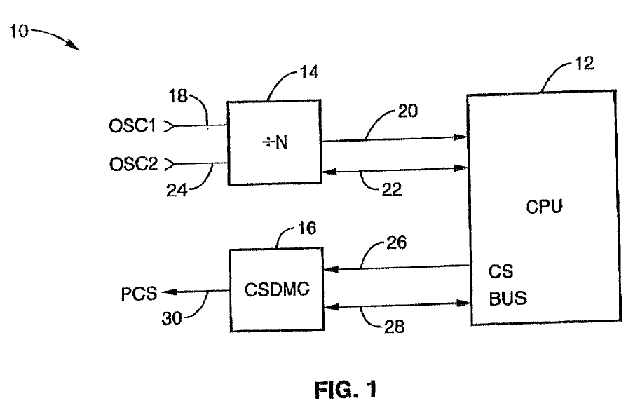

Referring more specifically to the drawings, for illustrative purposes the present invention is embodied in the apparatus generally shown in FIG. 1 through FIG. 5. It will be appreciated that the apparatus may vary as to configuration and as to details of the parts, and that the method may vary as to the specific steps and sequence, without departing from the basic concepts as disclosed herein.

FIG. 1 depicts a selectable clock speed processor operating with a chip select duration modulation circuit 10. A central processing unit 12, processor, is shown connected to a selectable processor clock device 14 and a chip select duration modulation circuit (CSDMC) 16. The duration of the instruction cycles of processor 12 are determined by the frequency of an oscillator signal 18, as modified by the selectable processor clock device 14 to be received as processor clock 20. Preferably, CPU 12, selectable processor clock device 14, and chip select duration modulation circuit 16 are wholly or partially integrated within a single processing element, such as a microprocessor, microcontroller, digital signal processing device, central processing unit, or similar. It will be appreciated that processor clock device 14 is under the control of processor 12 wherein the frequency of oscillation is subject to control, as indicated by clock control signal 22, by the program that is executing on processor 12. Preferably the processor clock device is configured to divide the incoming clock frequency by a number greater than one to selectively reduce the speed of the processor under program control. Alternatively, the processor clock device may divide the incoming signal by a number less than one, wherein the processor clock may be sped up under program control. It should also be appreciated that processor clock device 14 is capable of receiving additional oscillator signals 24 which may be selected for connection to processor 12 as a processor clock. Processor 12 is configured to output conventional chip select outputs 26 to peripheral devices which may also connect to various other processor bus signals as illustrated by bus 28, such as data, read strobe, write strobe, and so forth. In the present invention the conventional chip select signals 26 are modulated by the chip select duration modulation circuit 16 so that the duration of the chip select outputs may be modified in response to the processor clock speed. Preferably, chip select modulation circuit 16 operates to narrow the relative width of chip select outputs in relation to the processor clock speed to reduce peripheral power dissipation. An indication of processor clock speed may be communicated from the processor element 12 to chip select modulation circuit 16 in a number of forms. The preferred form of indicating clock speed is as a binary values on control lines which can be decoded into discrete processor clock division values. The peripheral devices, not shown, may comprise either I/O devices or memory devices. Power-saving chip select signals (PCS) 30 are shown being output by the chip select duration modulation circuit 16 for connection to peripheral devices (not shown).

It will be appreciated that a processor operating at a fixed frequency is typically paired up with peripherals which exhibit similar timing characteristics to provide a power efficient interface. However, when operating a processor at a selected lower clock speed, the length of the chip select signals applied to the peripheral devices can extend well beyond the setup times required by the device and thereby lead to unnecessarily high power consumption levels. The present invention is capable of reducing power consumption within peripherals and may be incorporated within or connected for use with processing elements capable of programmed multi-speed operation.

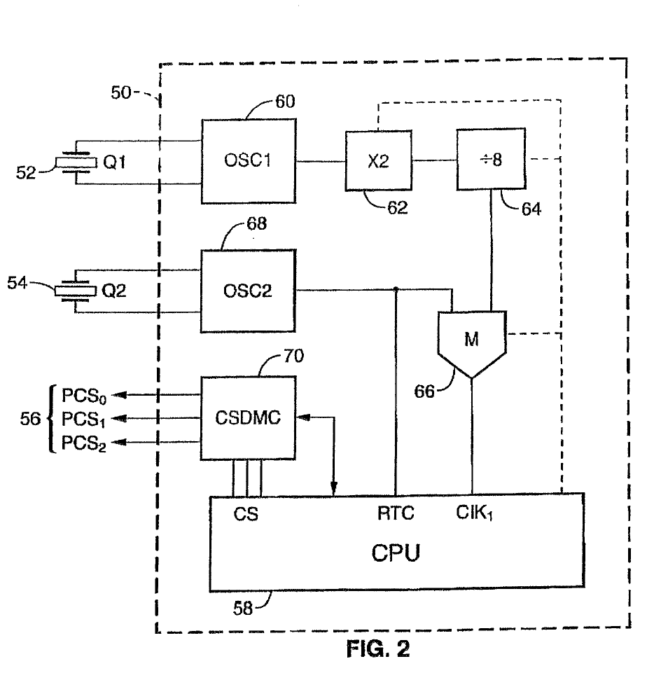

FIG. 2 illustrates another embodiment of the present invention showing a programmed multi-speed processor circuit 50 which provides modified chip select signals having a duration and timing that is in response to processor clock speed. Processor circuit 50 is shown connected to a first crystal 52, a second crystal 54, and outputting a series of power-saving chip select outputs 56. The multi-speed processor circuit 50 is shown comprising a central processing unit 58 configured for receiving an execution cycle clock along with a real-time clock input. First crystal 52 is shown connected to an oscillator 60 whose output passes through a selectable clock multiplier circuit 62, shown configured for selective doubling of the clock speed, and a selectable divider 64, shown configured for selective division of the clock speed by a factor of eight. The modified execution cycle clock is received by the processor through multiplexor 66 which allows the selection of a divided speed oscillator signal or a signal from an alternative oscillator. The alternative oscillator is provided by crystal 54 connected to oscillator circuit 68 that is preferably configured for use by a real-time clock circuit, but may be selected for providing a very low speed clocking signal for CPU 58. It will be appreciated that the program being executed by CPU 58 is capable of controlling under program execution, the selectable oscillator division and multiplier ratios, as well as the selection of the alternative oscillator input.

It will be appreciated that CPU 58 configured within processor circuit 50 is preferably capable of operating in a number of selectable processor clock modes. In a processor clock “divider mode” the frequency of oscillation from first crystal 52 and associated oscillator 60 may be divided up or down by the multiplier circuit 62 or divider circuit 64 as controlled by CPU 58. Utilizing a frequency multiplier circuit allows the processor clock to be sped up from the received oscillator speed, while the frequency divider allows the processor clock speed to be reduced in relation to the received oscillator frequency. It will be appreciated that frequency multiplication and division may be utilized separately or in conjunction to provide a variety of processor speed settings. It should be further appreciated that the use of either multiplier or division mechanisms can allow the speed of a processor to be reduced to a speed below the peak operating clock speed as determined by which state defines default processor speed. In the exemplified embodiment, the peak operating clock speed is double the frequency of first oscillator 60, while the slowest speed is achieved with the multiplier circuit disabled and the divider set to divide the incoming clock frequency by eight. It will be further appreciated that the multiplier and division circuits may be implemented by one of ordinary skill in the art for providing various programmable scaling factors without departing from the present invention.

When operating below peak clock speed in “divider mode”, the chip select signal output to the peripherals conventionally spans a duration which significantly exceeds the required peripheral setup times. A chip select duration modulation circuit (CSDMC) 70 is shown interfaced with CPU 58 for modulating the conventional peripheral chip select outputs according to the selected speed of the processor. The chip select duration modulation circuit (CSDMC) 70 generally comprises a clock speed detection circuit, a chip select restriction circuit, and a chip select gating circuit. It will be appreciated that the typical oscillator frequency received by a processor, such as CPU 58, is utilized for driving processor states, often referred to as “T-states”, a sequence of which are required within each instruction cycle. During low speed operation of the exemplified divider circuit, the oscillator frequency may be divided by eight which accordingly decreases power consumption by approximately a factor of eight.

Chip select duration modulation circuit 70 is preferably configured to enable the power-saving chip selects 56 for only the number of clock periods necessary to satisfy access timing requirements for the peripheral devices, such as memory devices. The exemplified power-saving chip select circuit enables the peripherals for the final two clock cycles within an instruction cycle, which results in a chip select duration of approximately one-eighth of conventional duration for a processor clock which has been divided by a factor of eight. One preferred method of implementing the circuit with static memory is by utilizing standard logic devices with a clock edge near the end of the memory cycle being utilized for gating the chip select signals so as to narrow the duration of the chip select signals when the processor is operating below peak operating frequency. It will be appreciated, however, that one of ordinary skill in the art may combine any of various processor related signals in response to the selected processor clock frequency to create a signal that may be used to modulate the duration of the peripheral chip select signals in accord with their timing requirements so as to reduce chip select duration and operating power requirements without departing from the teachings of the present invention. It will further be appreciated that the chip select signal may be alternatively modulated by increasing its duration in the case of multiplied speed processor operation, although the employment of peripheral devices incapable of keeping pace with the processor at peak operating speed are expected to be far less prevalent.

Processor circuit 50 is additionally shown configured for operation in an alternative oscillator clock mode, that is illustrated within FIG. 2 as a “low frequency clock mode” preferably for providing low speed operation at under approximately one hundred kilohertz (100 kHz). The low frequency clock mode is exemplified by the selection of the oscillator signal, such as at an approximate frequency of thirty two kilohertz (32 kHz), utilized by the real-time clock circuit that may be selected for use as a very low speed processor clock. The generation of an adjusted duration chip select signal is more difficult in this very low speed mode because the clock cycle is much longer than the required access time, and no narrow width clocking signals are available near the end of the memory cycle to enable the chip select so as to minimize power usage while satisfying access timing requirements. Therefore, in order to reduce the chip select duration toward its allowable minimum value associated with a peripheral device, the chip select is preferably generated by a timing circuit, such as a monostable multivibrator, or a delay line, as triggered by signals within the system. Within the exemplified chip select duration modulation circuit the chip select signal is pulsed on a clock edge before the end of the memory cycle and is timed according to peripheral timing requirements, such as by a silicon delay line internal to chip select duration modulation circuit 70. At the end of the pulse the output data from the memory device is captured in latches and held to the end of the memory cycle where the data is presented to the microprocessor as if it came from a memory device at that time, but not necessarily driving the external data bus.

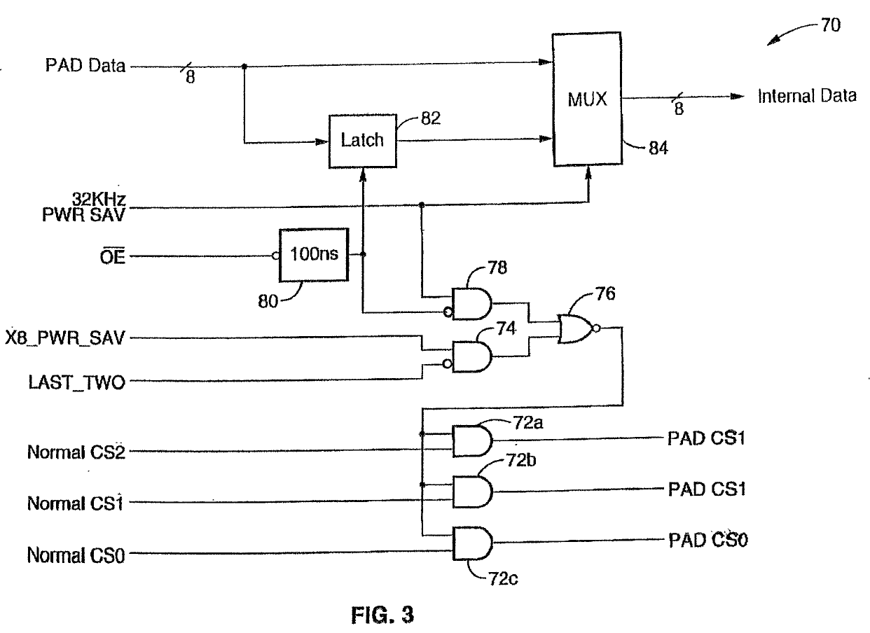

FIG. 3 through FIG. 5 depict a chip select duration modulation circuit 70 and associated waveforms which provide for the reduction of chip select duration in response to selected processor speed. The circuit 70 is shown for modulating the duration of the chip select signals when the processor is configured for receiving a clock divided by eight or when receiving the alternative clock associated with the real time clock input. A set of three conventional chip select signals are received by AND gates 72a through 72c, the other input receiving a chip select restriction signal wherein the output of the gates produces a restricted duration power-saving chip select output.

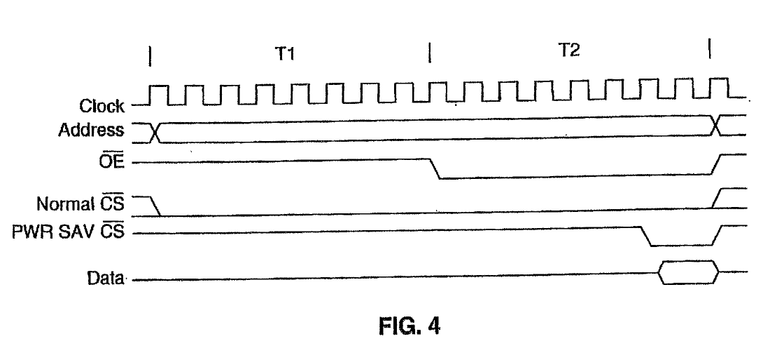

When operating in the divide-by-eight mode the signal X8_PWR_SAV is active, whereby AND gate 74 is configured to output the signal LAST_TWO which is a signal derived from the processor timing signals which span the last two states within an instruction cycle. The signal LAST_TWO passes through NOR gate 76 to modulate conventional chip select signals to produce power-saving chip select signals. The timing for this circuit is shown in the waveform of FIG. 4.

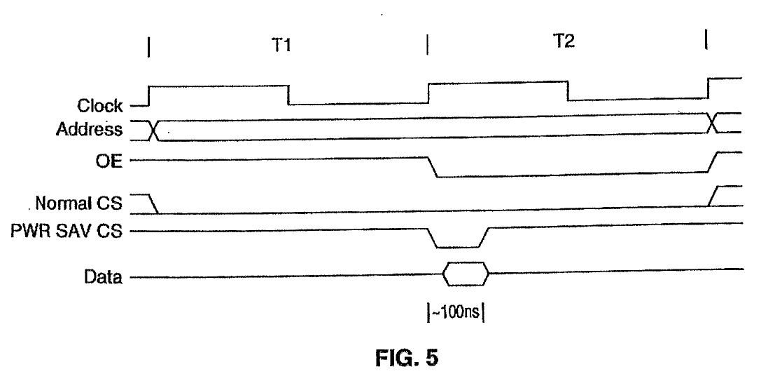

In driving the processor from the alternative clock, exemplified as 32 kHz, an AND gate 78 receives an output enable signal stretched by a timing circuit 80 when the processor clock speed of 32 kHz_PWR_SAV is selected. It will be appreciated that timing circuit 80 can be configured to generate a shorter duration chip select signal than may be derived by combinatorial logic circuits in relation to the low speed 32 kHz oscillator. It should also be appreciated that processor control signals may be modified to properly configure the interface with the peripheral devices for multi-speed operation. A data latch 82 and a multiplexor 84 are shown being utilized in conjunction with the low clock frequency mode to properly stretch the timing of data bus signals in accord with the output enable signal. The timing for the low speed oscillator is shown in the waveform of FIG. 5.

The low frequency clock mode is exemplified with a 32.768 kHz oscillator driving the microprocessor wherein the resultant conventional chip select signals are set for a duration far in excess of that required by the peripheral. It will be appreciated that memory devices are typically manufactured with access times of one hundred nanoseconds (100 nS) or less. In comparison, the use of the last two clock cycles during very low speed operation at 32.768 kHz to time the chip select duration would result in an active chip select signal that spans sixty microseconds (60 uS). As no convenient clock edges exist for terminating the chip select signal within this embodiment, the duration of the chip select signal is preferably created by utilizing a timing circuit 80. The power-saving chip select is configured to start on an interior edge and after the expiration of an internal delay exemplified as one hundred nanoseconds (100 nS) the chip select signal is terminated. The chip select duty cycle in this particular example is thereby reduced by a factor of approximately six hundred (100 nS/ 60 uS)=1/600, thus greatly reducing the power consumed by the memory device interfaced with the processor. It will be appreciated that chip select could be gated starting on the first edge before the end of the cycle, however, this would only reduce the duty cycle by a factor of four which results in less beneficial power-savings. A similar chip select reduction can be implemented for write cycles, however, it should be appreciated that write cycles are generally far less prevalent in processor applications such that the added circuitry may not be warranted if the power-savings produced would be marginal.

Accordingly, it will be seen that this invention provides circuits and methods for modulating instruction execution speed within a microprocessor to reduce power consumption, in addition to concomitant chip select duration modulation to reduce power consumption within peripherals. It will be appreciated that the circuits and methods described herein may be implemented within various processing elements and that variations may be implemented by one of ordinary skill in the art without departing from the present invention. Specifically, the modification of oscillator frequency under program control may be implemented in a number of forms wherein an oscillator signal is either increased or reduced, either directly or by selecting an alternative oscillator signal. Furthermore, the circuits which perform the processor selective modulation of chip select signals associated with a given oscillator frequency may be implemented with various forms of combinatorial logic, sequential logic, timer circuits, programmable devices, custom circuitry, and so forth which provide chip select timing which is synchronized to the processor clock and responsive to the particular processor clock speed selected.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the abovedescribed preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for executing application programming at reduced circuit power consumption levels, comprising:
(a) a processing element; and
(b) means for modulating the clock speed of said processing element under the control of an application program executable on said processing element.

2. An apparatus as recited in claim 1, wherein the clock speed modulation means under program control is configured to allow the selection of at least two clock speeds.

3. An apparatus as recited in claim 1, wherein the clock speed modulation means comprises a divider circuit configured to divide an incoming oscillator signal which is received by said processing element and from which processor clock speed is derived.

4. An apparatus as recited in claim 3, wherein the divider circuit is configured to divide the incoming oscillator signal by a value greater than unity, such that the oscillator signal provided to the processor is less than the incoming oscillator frequency.

5. An apparatus as recited in claim 4, wherein the divider circuit is configured to have at least one discrete division value that may be selected by the executing program.

6. An apparatus as recited in claim 5, wherein the incoming oscillator signal may be divided by eight under program direction and supplied to the processing element.

7. An apparatus as recited in claim 3, wherein the divider circuit is configured to divide the incoming oscillator signal by a value less than unity, wherein the oscillator signal provided to the processor is greater than the incoming oscillator frequency.

8. An apparatus as recited in claim 7, wherein the divider circuit is configured with at least one discrete division value that may be selected by the executing program.

9. An apparatus as recited in claim 8, wherein the incoming oscillator signal may be divided by one-half under program direction, wherein the speed of the oscillator signal supplied to the processing element is therefore doubled.

10. An apparatus as recited in claim 1, wherein the clock speed modulation means comprises a circuit configured to select an alternative oscillator signal for the processing element.

11. An apparatus as recited in claim 10, wherein the alternative oscillator signal comprises a lower frequency oscillator that is otherwise utilized for driving a realtime clock circuit.

12. An apparatus as recited in claim 1 1, wherein the alternative oscillator is at a frequency of less than 100 kHz.

13. An apparatus as recited in claim 11, wherein the alternative oscillator is at a frequency of approximately 32 kHz.

14. An apparatus as recited in claim 1, wherein the clock speed modulation means is integrated within the processing element.

15. An apparatus as recited in claim 1, further comprising:
(a) means for modifying the duration of peripheral device chip selects being output by said processing element; and
(b) said chip select duration modifying means configured to change duration of at least one chip select signal in response to the selected clock speed of the processor such that peripheral access timing requirements are met while limiting the power consumption of the peripheral device associated with device selection.

16. An apparatus as recited in claim 15, wherein the chip select duration modification means comprises a digital circuit which receives processor timing signals and at least one conventional chip select signal from which it generates a power-saving chip select signal having a relative duration which is responsive to changes in processor clock speed.

17. An apparatus as recited in claim 16, wherein the digital circuit for modifying chip select duration comprises a timing circuit triggered by a processor timing signal.

18. An apparatus as recited in claim 16, wherein the digital circuit for modifying chip select duration comprises latching circuitry for sufficiently retaining data integrity according to the timing of the power-saving chip select signal.

19. An apparatus as recited in claim 15, wherein the chip select duration modification means is integrated within said processing element.

20. In a processing element configured for operation at a clock speed as derived from an oscillator, wherein the improvement comprises:
(a) an oscillator frequency modification circuit;
(b) said oscillator frequency modification circuit being configured to modify the frequency received by the processing element as an execution clock; and
(c) said oscillator frequency modification circuit is configured to respond to the programmed instructions executing on said processing element to allow changing processor execution speed.

21. In the processing element as recited in claim 20, wherein the processing element is an electronic circuit or device capable of executing programmed instructions as selected from the group of devices and circuits consisting of microprocessors, microcontrollers, digital-signal processors, and central processing units.

22. In the processing element as recited in claim 20, wherein the oscillator frequency modification circuit comprises a selective oscillator divider circuit which divides an incoming oscillator signal under program control to be utilized as the clock within the processing element.

23. In the processing element as recited in claim 22, wherein the selective oscillator divider is configured to divide the incoming oscillator signal by a value greater than unity when directed by the executing program, such that the clock speed of the processing element may be reduced.

24. In the processing element as recited in claim 22, wherein the selective oscillator divider is configured to divide the incoming oscillator signal by a value less than unity when directed by the executing program, such that the clock speed of the processing element may be increased.

25. In the processing element as recited in claim 20, wherein the oscillator frequency modification circuit comprises an oscillator selection circuit configured to allow the selection of at least one alternative oscillator under program control to be utilized as the clock within the processing element.

26. In the processing element as recited in claim 20, wherein the oscillator frequency modification circuit is integrated within the processing element.

27. In an electronic circuit containing a processor element configured for operation at more than one clock frequency, and to which chip select outputs are interfaced to peripheral devices, wherein the improvement comprises:
(a) a chip select timing circuit which generates a signal in response to processor element clock frequency and timing; and
(b) a gating circuit which receives a signal from said chip select timing circuit and in response alters the percentage interval over which chip select outputs to the peripheral devices are active.

28. In the electronic circuit as recited in claim 27, wherein the processing element is an electronic circuit or device capable of executing programmed instructions as selected from the group of devices and circuits consisting of microprocessors, microcontrollers, digital-signal processors, and central processing units.

29. In the electronic circuit as recited in claim 27, wherein the peripheral devices comprise memory devices.

30. In the electronic circuit as recited in claim 29, wherein the memory devices comprise static memory integrated circuits.

31. In the electronic circuit as recited in claim 27, wherein the electronic circuit comprising the chip select timing circuit and gating circuit are integrated within a processing element.

32. A circuit for modulating the duration of chip select signals in association with a processor element capable of operating with a selectable cycle clock, comprising:
(a) a processor clock speed detection circuit;
(b) a chip selection restriction circuit connected to said clock speed detection circuit;
(c) said chip selection restriction circuit receiving one or more signals associated with said processor element and configured to generate a restricted chip select signal in response to processor clock speed; and
(d) a chip select gating circuit which receives said restricted chip select signal for modulating at least one chip select output signal to at least one peripheral device of the processing element.

33. A circuit as recited in claim 32, wherein said chip selection restriction circuit is configured to generate an output responsive to selected periods of the oscillator clock within a given instruction cycle.

34. A circuit as recited in claim 33, wherein the selected periods of said oscillator clock comprise a given multiple of periods at a predetermined position within a given instruction cycle.

35. A circuit as recited in claim 34, wherein selected periods comprise the last two periods within a given instruction cycle.

36. A circuit as recited in claim 32, wherein said chip selection restriction circuit is configured with a timer circuit that generates a signal of predetermined duration as triggered by a processor signal.

37. A circuit as recited in claim 36, wherein the timer circuit is triggered by an output enable signal from the processor element.

38. A circuit as recited in claim 32, wherein the chip select gating circuit logically combines said restricted chip select signal to conventional peripheral chip select signals to generate new power-saving peripheral chip selects whose relative duration is responsive to processor clock speed.

39. A circuit as recited in claim 38, wherein the logical combination comprises ANDing of a conventional chip select signal with that of the restricted chip select signal to generate the new power-saving peripheral chip select.

40. A circuit for reducing the operating current for devices which interface to a processing element that utilizes a selectable frequency processor clock, comprising:
(a) a chip select timing circuit which interfaces with said processing element;
(b) said chip select timing circuit receiving at least one signal indicative of the selected frequency of the processor clock;
(c) said chip select timing circuit receiving at least one timing conditioning signal;
(d) said chip select timing circuit logically combining said received signals into a chip select restriction signal;
(e) a gating circuit which utilizes the chip select restriction signal to gate at least one received chip select signal; and
(f) said gating circuit generating altered chip select signals that have a timing and pulse width configured in response to processor element clock speed.

41. A circuit as recited in claim 40, wherein the signal indicative of the selected frequency of the processor clock comprises a division value.

42. A circuit as recited in claim 40, wherein the processing element is configured for a selectable frequency processor clock by dividing a received clock signal for use as a cycle clock.

43. A circuit as recited in claim 40, wherein the processing element is configured for a selectable frequency processor clock by multiplying a received clock signal for use as a cycle clock to thereby scale up the normal speed of the processor clock.

44. A circuit as recited in claim 40, wherein the processing element is configured for a selectable frequency processor clock to allow the selection of an alternate oscillator input to drive the processor clock.

45. A circuit as recited in claim 44, wherein the alternate oscillator is configured as a low frequency oscillator.

46. In an electronic circuit containing a processor element configured for operation at more than one clock frequency, and to which chip select outputs are interfaced to peripheral devices, wherein the improvement comprises:
a chip select timing circuit which generates a signal in response to processor element clock frequency and timing; and
a gating circuit which receives a signal from said chip select timing circuit and in response alters the percentage interval over which chip select outputs to the peripheral devices are active.

47. In the electronic circuit as recited in claim 46, wherein the processing element is an electronic circuit or device capable of executing programmed instructions as selected from the group of devices and circuits consisting of microprocessors, microcontrollers, digital-signal processors, and central processing units.

48. In the electronic circuit as recited in claim 46, wherein the peripheral devices comprise memory devices.

49. In the electronic circuit as recited in claim 46, wherein the memory devices comprise static memory integrated circuits.

50. A method of reducing power consumption within a processing element receiving an oscillator signal for driving its clock speed, comprising:
generating a processor clock speed control signal in response to programmed instructions being executed on said processing element; and
modifying the frequency of the oscillator signal in response to said processor clock speed signal.

51. A method as recited in claim 50, wherein the modification of the frequency of the oscillator signal comprises dividing the incoming oscillator frequency.

52. A method as recited in claim 50, wherein the modification of the frequency of the oscillator signal comprises multiplying the incoming oscillator frequency.

53. A method as recited in claim 50, wherein the modification of the frequency of the oscillator signal comprises selecting an alternative oscillator to be utilized by the processor element for driving the clock speed.

54. A method of reducing power consumption in a circuit containing a processing element configured for multiple clock speed operation which is interfaced to peripheral devices, comprising:
generating a processor speed selection signal that is responsive to the selection of processor element clock speed;
deriving a chip select restriction signal from the processor speed selection signal and timing signals within said processor element; and
gating chip select signals communicated to the peripheral devices with the chip select restriction signal to modulate the active periods of the peripheral devices to provide for reduced levels of power consumption.

55. A method as recited in claim 54, wherein the duration of the chip select restriction signal is derived from a timer circuit triggered by timing signal within said processing element.
